(19) United States
(12) Patent Application Publication
(10) Pub. No.: US 2005/0171907 A1
(43) Pub. Date: Aug. 4, 2005

(54) Interconnected remote banking facilities and method

(76) Inventor: John M. Lewis, Fayetteville, AR (US)

Correspondence Address: KEISLING, PIEPER & SCOTT PLC;Bank of America Plaza, Suite 217, 1 East Center Street, Fayetteville, AR, 72701, US

(21) Appl. No.: 10/769,424

(22) Filed: Jan. 30, 2004

(51) Int. Cl. G06F 17/60

(52) U.S. Cl. 705/43; 705/42; 705/64

(57) ABSTRACT

There is disclosed a communication and control system connecting geographically separated untended branch bank facilities with a central control facility having audio visual personnel stations for customer service persons with video monitors switchable to receive visual data from a selected branch bank. Video cameras are provided for communicating an image of a service person and control signals to a branch bank. A central security control station receives digital image data from the branch banks. The branch bank facilities have intrusion detection and prevention apparatus and entry control devices for allowing access to authorized persons, and video cameras which are situated and controlled to view all parts of the bank and linked to said central control. Customer stations have a personal computer terminal to communicate with an internet electronic banking site and also may have conventional automated equipment such as a bulk cash dispensing machine, a check cashing machine, a night depository unit, and at least one recording security camera. A terminal at central control has digital data links to cash dispensing and check cashing machines.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

Remote banking facilities such as branch banks have been known and widely used particularly in urban areas for many decades. The size of banking establishments has grown over time particularly in terms of the number of customers so that it is a virtual necessity that branch bank facilities exist to serve large numbers of customers over substantial urban and suburban areas. In addition there are now banking institutions of great size of regional, national, or international scope increasing further the number of facilities required by one banking institution to service its customers. Characteristically banking institutions have had one or more main banks with virtually all banking and related service capabilities, and, associated therewith, smaller branch bank facilities having limited capability. For example, the branch facilities might not engage in making certain types of loans or perform services related to unusual or involved business or commercial transactions.

Normally, branch bank facilities have been fully staffed with tellers and other service personnel who conduct on-site the scope of activities of which the branch bank was capable. As the need for improved customer access increased, drive thru teller stations were incorporated in main banking and branch banking facilities. Also, unstaffed or untended facilities in the form of automatic teller machines (ATM's) have been extensively employed to further increase accessibility to the customers while somewhat decreasing the staff required to provide such accessibility. Although automatic teller machines have progressed beyond the point of merely being currency dispensers and means for transfer of funds between accounts they have not successfully been able to perform many teller functions such as identifying customers cashing checks, etc. in the manner of main or branch banking facilities that is appropriately staffed.

There is a need for a remote banking facility similar to a branch bank which is provided with the most advanced communication and control utilities thereby virtually eliminating the requirement for on-site staff for normal operations. This would provide to the customer at a remote location distant from the main bank a full range of services extending from self-service to obtain small amounts of currency, large amounts of currency or coins up to and including video conferencing with an executive at the main bank facility to process a loan, investment transaction or the like. The desirability of face to face communication capability would be satisfied, and the necessity for customers to travel to a fully staffed main or branch banking facility would be virtually eliminated. In spite of numerous technological advances that would aid in its achievement, implementation of the full service untended branch bank facility has not been accomplished. The many requirements for success have not been met in such facilities that have been attempted or proposed.

A combination of many factors is necessary to overcome the difficulties in developing a full capability untended branch bank facility. The principle ones of these requirements will be seen to be: 1) controlled access to interior; 2) automatic customer identification; 3) customer personal security (inside and outside); 4) property security for bank and customer property; 5) communication security and confidentiality; 6) virtual face to face customer service option; 7) equipment providing automated personal and commercial bank transactions to match those available from staffed locations; 8) document transmission capability; 9) available interface with e-banking systems.

Many of these desirable features or components have been suggested or disclosed in prior art U.S. patents or U.S. published applications but such disclosures have not been combined in a way to fully satisfy the requirements believed to be necessary for an internet connected remote banking facility system requiring virtually no on-site staffing at the branch banks.

Among the existing disclosures of potential system components there are a number of U.S. patent documents relating to remote banking facilities with electronic communication for customer interaction and for customer access to the internet. For example, U.S. patent application Pub. No. 2003/0066876 dated Apr. 10, 2003 for “Web Enabled Bank Teller Machine”, Assignee unknown; U.S. Pat. No. 6,223,983 dated May 1, 2001 for “Interactive Point Access Financial and Information System”, Assignee National City Bank, Minneapolis, Minn.; U.S. Pat. No. 6,073,119 dated Jun. 6, 2000 for “Method and System for Banking Institution Interactive Center”, Assignee Citicorp Development Center, Inc.; U.S. Pat. No. 5,600,114 dated Feb. 4, 1997 for “Remote Unmanned Banking Center”, Assignee Facilities Engineering and Design Consultants, Inc.; U.S. Pat. No. 3,876,864 dated Apr. 8, 1975 for “Teller-Assisted Currency Dispenser System”, Assignee Diebold Incorporated.

Other U.S. patents show systems for central communication and control of a group of remote banking facilities exemplified by U.S. Pat. No. 6,286,756 dated Sep. 11, 2001 for “Cardless Automated Teller Transactions”, Assignee InnoVentry Corporation; U.S. Pat. No. 5,717,867 dated Feb. 10, 1998 for “Employee Time Entry and Accounting System”, Assignee Mirage Resorts, Incorporated; U.S. Pat. No. 5,929,897 dated Jul. 27, 1999 for “Automated Distribution of Video Telephone Calls”, Assignee NCR Corporation; U.S. Pat. No. 3,654,604 dated Apr. 4, 1972 for “Secure Communications Control System”, Assignee Constellation Science and Technology Corporation.

Automatic teller machines have provided some customer service functions that are also provided in the interconnected remote banking facility of the invention, as shown in the following disclosures: U.S. Pat. No. 6,443,359 dated Sep. 3, 2002 for “Automated Transaction System and Method”, Assignee Diebold,Incorporated; U.S. Pat. No. 6,199,754 dated Mar. 13, 2001 for “Self-Service Terminal”, Assignee NCR Corporation; U.S. Pat. No. 6,045,039 dated Apr. 4, 2000 for “Cardless Automated Teller Transactions”, Assignee Mr. Payroll Corporation; U.S. Pat. No. 5,987,439 dated Nov. 16, 1999 for “Automated Banking System for Making Change on a Card or User Account”, Assignee Capital Security Systems, Inc.; U.S. Pat. No. 4,025,905 dated May 24, 1977 for “System for On-Line Processing of Banking Transactions”, Assignee Incoterm Corporation.

Also, with respect to the check cashing capability provided by the present invention there are prior disclosures of implementation of that basic feature exemplified in the following patents: U.S. Pat. No. 6,149,056 dated Nov. 21, 2000 for “Automatic Check Cashing Using Biometric Identification Verification”, Assignee Mr. Payroll Corporation; U.S. Pat. No. 6,145,738 dated Nov. 14, 2000 for “Method and Apparatus for Automatic Check Cashing”, Assignee Mr. Payroll Corporation; U.S. Pat. No. 4,580,040 dated Apr. 1, 1986 for “Teller-Assisted, Customer-Operated ATM Check Cashing System”, Assignee NCR Corporation; U.S. Pat. No. 4,109,238 dated Aug. 22, 1978 for “Apparatus for Verifying Checks Presented for Acceptance”, Assignee 1st Natl. Bank of Atlanta.

The desirable rolled coin dispensing feature of the present invention is basically disclosed in prior documents such as U.S. Pat. No. 5,938,072 dated Aug. 17, 1999 for “Rolled Coin Dispenser”, Assignee Magner Corporation; U.S. Pat. No. 5,110,009 dated May 5, 1992 for “Coin Roll Dispensing Mechanism”, Assignee Alan K. Uyeda.

Customer depository units for night deposit and the like are of course well known and depository units for untended banking equipment is shown in U.S. Pat. No. 4,085,687 dated Apr. 25, 1978 for “Remote Envelope Depository Construction”, Assignee Diebold, Incorporated; U.S. Patent Application Publication No. 2001/0013541 dated Aug. 16, 2001 for “Document Sensor for Currency Recycling Automated Banking Machine”, Assignee Diebold, Incorporated.

The foregoing discussion of the state of the art shows that while electronic and electromechanical equipment has been developed extensively for automating various forms of banking services, there is no known successful attempt to combine the known equipment and instrumentalities to provide a network of centrally controlled essentially unattended branch bank facilities with capabilities equal or nearly equal to those of on-site staffed branch bank facilities of conventional form.

### SUMMARY OF THE INVENTION

The present invention provides the means for achieving improved bank customer access with branch bank units that have substantially full service capabilities without requiring on-site staff. Branch banking is a prominent feature of banking systems in the United States and elsewhere at the present time. In the 1960's, all states in the United States did not allow branch banking, and there were only approximately 12,000 branch banks in the United States. The Bank of America, the largest bank in California had only about 100 branches.

Branch banking has greatly increased and is very essential to modern day banking systems. While it has been proposed that economies would be possible by reducing staffing at branch banking facilities; automated teller machines (ATM's) have been developed and employed with that objective (also the objective of 24 hour accessibility). Branch banks otherwise have customarily been provided with substantial on-site staffs.

In order for a branch bank without on-site staff to be acceptable, it must meet many requirements and overcome a number of problems. The present invention addresses these requirements and problems by organized use of technology with careful anticipation of prospective problems. One requirement deemed necessary for a successful untended branch bank facility is control of access to the interior of the bank's structure with automated customer identification using magnetic stripe cards, RFID tags, smart cards, or the like, supplemented by video monitoring capability and/or biometric recognition technology.

Video monitoring inside and outside the banking structure also is an important feature necessary for customer personal security complementing the controlled access features of the installation. Property security is associated with personal security, but also is an aspect for electronic account transactions or automated delivery of bulk currency or rolled coins. Information transmission security is also of importance so that confidential communications between the customer at the branch bank facility and the main bank facility remain confidential and secure through encryption or other means.

To overcome customer reluctance to transact business in an impersonal manner it is essential that those customers desiring it have virtual face to face customer service by video link to the main bank tellers or other staff. Preferably a capability of complete video conferencing with document transmission capability with a bank officer or other staff at the main bank is provided.

It is contemplated that many customers would prefer convenient non personal service, and automated bank transaction equipment suitable for remote locations is provided substantially equalling services available from staffed locations, including bulk currency and rolled coin deliveries, acceptance of deposits, and cashing of at least some third party checks.

The untended branch bank facility includes a personal computer or other suitable interface with e-banking systems, which are currently provided by almost all banking systems. As an important feature of the present invention, extensive use of internet links is employed for video communication with customers, video monitoring, some document transfer, and other communication links which the public internet is particularly well suited. Where desired the internet links can employ cryptographic security to preserve customer communication security. This is in addition to closed circuit links for automatic tellers and other conventional remote banking equipment.

In addition to providing the above features and advantages it is an object of the present invention to provide branch bank facilities in a branch banking system which do not require on-site staff and have controlled access to the interior of the branch bank structure with automatic customer identification, personal security for customers inside and outside the structure, and including technology to provide a virtual face to face customer service option for the customers as well as extensive automated services in lieu of staff provided services.

It is another object of the present invention to provide such untended branch bank facilities with rolled coin and bulk cash dispensing capability.

It is still another object of the present invention to provide such untended branch banking facilities with check cashing capability.

It is yet another object of the present invention to provide such untended branch banking facilities with an interface to e-banking systems and with bank deposit accepting capability.

It is still another object of the present invention to provide such untended branch banking facilities with extensive internet video, audio and data communication link capability in addition to customary closed circuit communication links for ATM's and the like.

Other objects and advantages of the present invention will be apparent from the following description in conjunction with the appended drawings.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a front elevational view of a branch bank facility broken away to show interior customer service equipment;

FIG. 2 is a plan view of the branch bank facility and customer service equipment of FIG. 1;

FIG. 3 is a front elevational view of the facility of FIG. 1;

FIG. 4 is a left side elevational view showing ATM equipment;

FIG. 5 is a right end elevational view showing customer entrance and access control details;

FIG. 6 is a rear elevational view of the facility of FIG. 1;

FIG. 7 is an interior front elevation detail view of coin dispenser-service unit-depository equipment;

FIG. 8 is a rear elevational of equipment shown in FIG. 7;

FIG. 9 is an elevation detail view of the ATM shown in FIG. 4;

FIG. 10 is a front detail view of an entry door customer access and ID unit;

FIG. 11 is a detail diagram of the external ID unit control panel of FIG. 10;

FIG. 12 is an interior view of customer service area of the facility shown in FIG. 1;

FIG. 13 is an interior perspective view, partially schematic, of a central control facility;

FIG. 14 is a schematic diagram of communication links structures for service equipment and facilities of FIGS. 1-13.

### DETAILED DESCRIPTION OF THE INVENTION

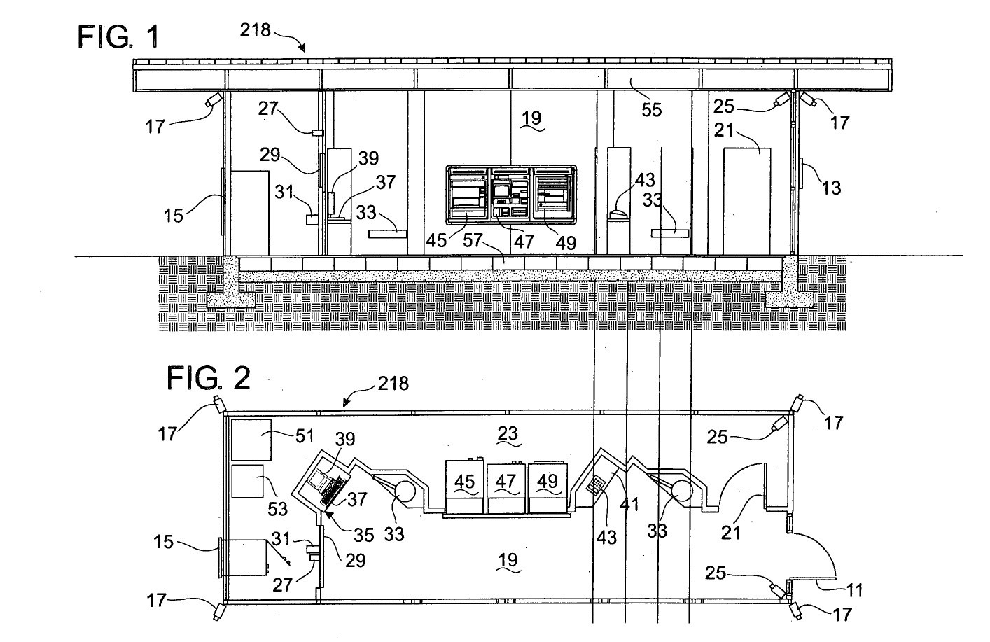

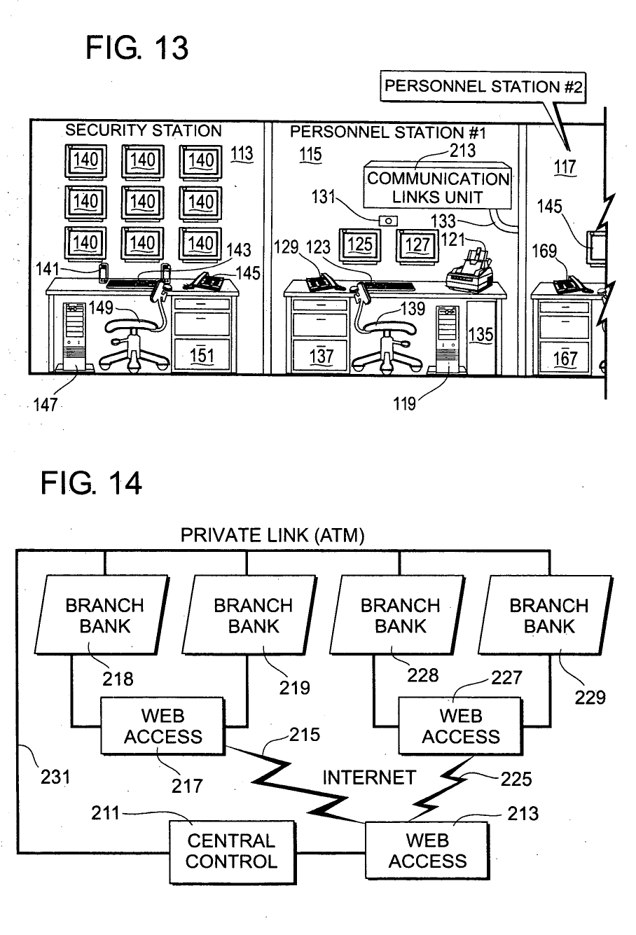

With reference to the drawings it will be noted that FIGS. 1-12 show the details of a representative one of a plurality of remotely located self-contained branch bank facilities while FIG. 13 shows a central control facility therefor and FIG. 14 is a diagram in partially schematic form of exemplary communication and control system communication links for the branch bank facilities and the central control facility. While FIG. 14 shows only four branch banks indicated at 218, 219, 228 and 229 with one central control 211 preferably at a main bank location, this configuration is by way of example only and the numbers of such units is virtually unlimited while their arrangement is subject to wide variation. In a similar manner the branch bank facility structure 218 shown in FIG. 1, by way of example, is subject to variation by increasing in greater or lesser degree the number and complexity of the customer service units and/or the area provided for customers.

The structure of the branch bank 218 shown in FIGS. 1-6, FIG. 12 may be generally conventional while especially suited to installation of bank customer automated service equipment and particularly to convenient access to communication and power cables for such equipment. All weather heating and cooling equipment for environmental control is provided the details of which are not shown in the drawings. As is customary, a high level of security against intrusion and detection thereof with communication to law enforcement and fire alarm protection is provided for the structure 218, but is not shown in detail.

A customer access door 11 as shown at the right of the structure 218 in FIG. 2 is an electronically locked controlled access door that can be unlocked by authorized persons using an entry control device 13 adjacent the access door 11 and also remotely by a control link to the central control facility 211. A conventional automatic teller machine (ATM) 15 is provided as shown at the left end of branch bank structure 218 as shown in FIGS. 1 and 2. In some instances it may be desired to have one or more stand alone ATM machine units exterior to the branch banking structure 218 either in place of the ATM shown at 15 or in addition to it.

Video cameras 17 are provided for monitoring the environment on the exterior of the building for security and other purposes. As shown in FIG. 2 for example there are video web cams 17 on the four corners of the building and these are preferably scannable cameras which can be oscillated or otherwise directed from a central control facility for monitoring the building and all approaches to it. As will be described in more detail later, the video cameras 17 are connected, preferably through the internet, for live monitoring at a central facility and/or digitally recording the images received.

The interior of the structure 218 is divided into two portions, a customer accessible portion 19 and a service access portion 23. A door 21 from customer accessible portion 19 to service access portion 23 is provided which will, of course, be locked to restrict entry to only authorized service personnel. The service access portion 23 may also be provided with an exterior door if desired.

Interior security cameras 25 are provided which will also be recording cameras as are commonly used for security purposes. Another video camera 27 is located with a large screen television display 29 to enable customers to have face to face interaction with centrally located bank staff; all video cameras mentioned 17, 25 and 27 are preferably equipped with audio communication capability as well as video. The large screen display 29 is preferably a flat panel display using LCD or plasma technology and is provided with an appropriate display driver unit 31.

A video capable customer station 37 is provided having a retractable seat 33 and a personal computer style keyboard 37 and display screen 39. The particular arrangement and placement of the display screen 29, the customer station 35, seat 33, keyboard 37 is indicated by way of example only and the number of such elements and their placement is subject to wide variation. The objective is to provide both video conferencing capability and e-banking access for customers admitted to the branch bank facility 218.

A customer station 41 is provided with a retractable seat 33 and a telephone 43 or other instrument for audio communication with the central control facility. As previously discussed, the customer station 41 can be arranged differently and may be provided with a display for visual communication. Also like the customer station 35 it may be duplicated or still more stations may be provided in a larger branch bank facility.

From the foregoing description it will be seen that extensive security is provided for the interior of the branch bank 218 and that customers are provided with an option of personal face to face interaction by video with centrally located bank staff. Furthermore, advanced automated service units are provided for maximized self service capability for those customers to which automated self service best fits their needs.

An illustrative example of automated service units for the branch banking facility is shown in FIGS. 1 and 2 at reference numbers 45, 47 and 49. A rolled coin dispenser unit 45, an interior full service teller and bulk cash dispenser unit 47, and a free standing depository unit 49 make up the advanced automated service unit assembly in branch bank facility 218.

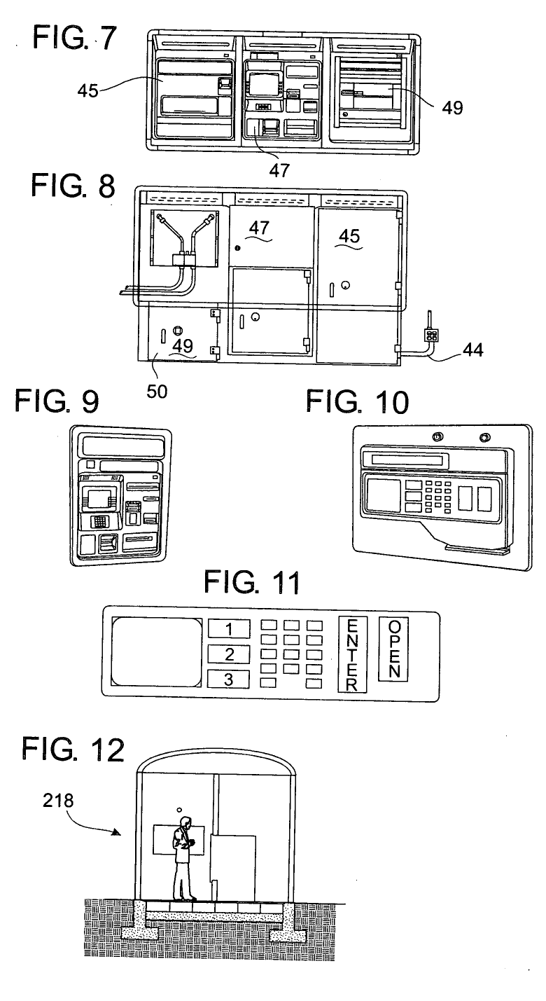

FIGS. 7 and 8 show front and rear views of the automated service units 45, 47 and 49. As shown in FIG. 8 power for the units is provided by a 110 volt power connection 44 while a digital communication connection is provided by cables 48. Also shown in FIG. 8 is the secure access door 50 for the depository unit 49. The equipment illustrated in FIGS. 7 and 8 is readily available conventional equipment available for example from Diebold Incorporated and others.

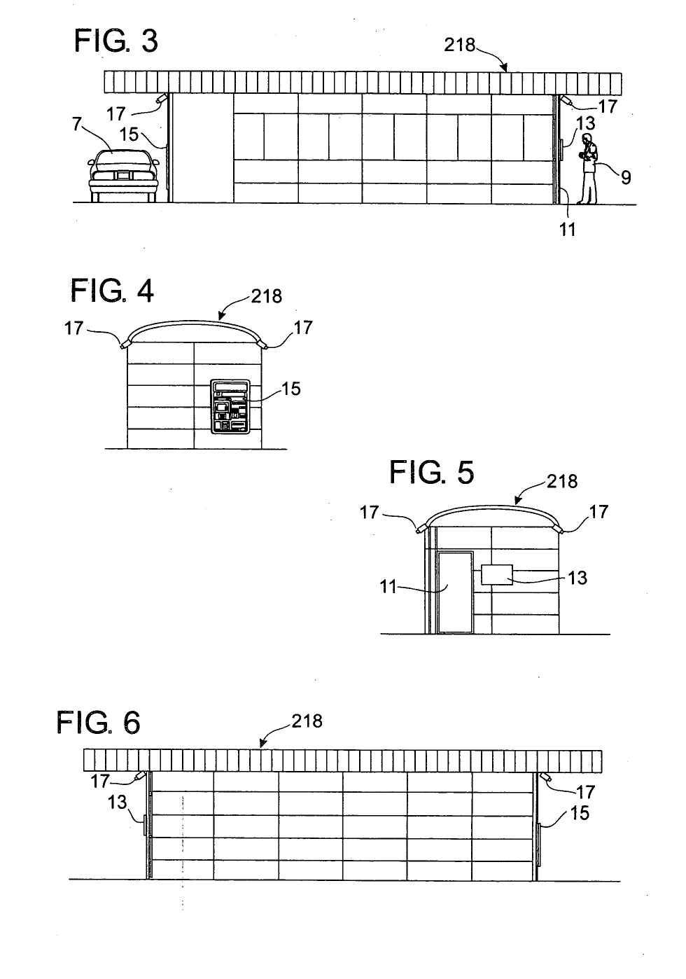

As shown in FIGS. 3-6, a customer 9 desiring entry to the branch bank facility 218 will approach the exterior entry door 11 and utilize the entry control device 13 to gain access to the interior. On the other end of the building customers approaching in an automobile 7 may utilize the exterior automatic teller 15 in the usual manner. Accordingly, customers are given the option of entering the branch banking structure 28 to utilize automated service equipment or alternatively to operate a conventional automatic teller machine 15 without leaving their automobile. Automatic teller machine 15 preferably is of the kind that includes a video camera for observing the automated teller machine customer. In addition, the cameras 17 on the 4 corners of the bank facility 218 provide total environment surveillance for the branch bank structure 218.

FIG. 9 shows an enlarged view of a conventional full service automatic teller machine 15 appropriate for exterior installation. Such machines are available from Diebold Corporation and other manufacturers.

FIG. 10 shows an enlarged view of entry control device 13 having a control panel 12 and a magnetic card reader 14. Card reader 14 may be replaced by some other identification data input device such as an RFID receiver transmitter. Entry control apparatus such as entry control device 13 are conventional available equipment which may also optionally be provided with biometric apparatus for accurately determining the identity of a customer desiring entry. An additional feature of the entry control device 13 is its linkage to central control facility 211 whereby entry may be authorized from central control in emergency situations or in unusual situations.

FIG. 11 shows an enlarged view of the input panel for entry control device 13 which includes a conventional display, numerical keypad, data enter button and door open button. Preferably the link from the entry control device to the central control facility also communicates the event of opening the door to the branch bank facility 218 and confirms that the door has closed following the customer's entry. The entry control device may also be programmed to determine the number of occupants and/or limit the number of customers allowed entry to the facility. In the event of unauthorized forcible entry, some or all customer service equipment may be disabled by control signals from a central control facility. If a need is determined, law enforcement personnel may be directed to the facility to deal with the unauthorized intrusion.

Important components of central control facility 211 are shown in FIG. 13. A security station 113 is provided with a number of video monitors 140, there being 9 video monitors 140 shown by way of example. A greater or lesser number of video monitors could be utilized and video monitors with a larger screen adapted to shown multiple images on one screen could be employed, thereby reducing the number of monitors required.

Monitors 140 are programmed to receive audio and visual information from webcams 17 and 25. Such program will preferably provide sequential viewing from the video cameras to reduce the number of monitors (or images displayed) at one time. Preferably the program will select video cameras which are detecting motion of viewed objects to be viewed most frequently and for the longest periods. Security station personnel will also control the program for video monitors 140 with the option of holding a view from a particular camera which is of interest and/or manually selecting a branch bank and a camera for display.

Audio communication from the branch bank cameras 25 is accessible from loud speakers 141. Selection of a branch bank facility for which audio is to be monitored by a loud speaker 141 may be actuated by sound detection, motion detection, or manually by security station personnel. Control is exercised by security station personnel by means of a conventional keyboard 143 or other input means including mouse, trackball, or voice command devices.

Internal and external telephone communication is provided by a communication device such as telephone 145. Usual internet and other computer functions as well as special computer functions discussed herein are provided by computer 147. Customary office equipment such as chair 149 and desk 151 is provided at the security station 113.

Another important component of central control facility 211 is one, and preferably several, personnel stations 115 and 117. Another important component is communication links unit 213 providing web access and a suitable interface for all communication paths utilized by the central control facility 211. Communication cable 133 provides the physical path for communication from central control facility 211 including copper wire pairs, DSL connection, microwave cable, and/or fiber optic cable. Closed circuit or internet wireless links may be employed in the system but are not essential to its operation.

Personnel station #1 shown at 115 includes a computer 119, a multi-function printer scanner 121, and a conventional keyboard 123 which may include devices providing other input options. A video monitor 125 is provided and preferably at least one further video monitor 127. A telephone 129 which may optionally include a headset for the service person at personnel station #1 is provided. As previously explained, an important feature of the system is providing optional face-to-face communication with branch bank customers and a video camera 131 is provided to enable this feature by transmitting the image of the customer service person to a video display 29 such as shown in FIG. 2. Personnel station #1 shown at 115 also is provided with a computer server 135 to implement any necessary networking among computers 119, 147 and others. Conventional office equipment in the form of a desk 137 and a chair 139 is provided for personnel station #1.

Personnel station #2 shown at 117 is shown only in part, and it will be understood that the personnel stations will be at least two in number and all will have equipment similar to that of personnel station #1 to serve the needs of personnel at the station. For example, the partial showing of personnel station #2 shows a monitor 145 similar to monitor 125 and telephone communication device 169 similar to 129 shown in personnel station #1.

The operation of the central control facility 211 with security station 113 and personnel stations such as 115 and 117 can better be understood by further reference to FIG. 14 in which it is shown that the system of interconnected remote banking facilities of the invention includes a branch bank 218 as shown in FIGS. 1-1,2 and described with reference thereto, together with other similar unillustrated branch bank facilities 219, 228 and 229. The branch banks 218, 219, 228, and 229 are connected through a private communication link 231 to the central control facility 211; this link is partially for the purpose of providing a standard communication link for automatic teller machines. The private link 231 may also serve all need for closed circuit communication not linked through the internet. For example, it may be used for an intrusion detection and alarm link functions apart from its ATM related functions.

It should be noted however, as shown in FIG. 14, that the major share of various types of information data communicated between central control in the branch banks utilizes the internet. Accordingly, the central control facility 211 is connected to transmit and receive data from a web access element 213 such as an internet service provider. In a similar manner, branch banks 218 and 219 are connected to web access element 217 while branch banks 228 and 229 are connected to web access element 227. It will be noted in FIG. 14 that two or more branch banks such as 218 and 219 may be connected to the same web access element 217 while one or more other branch banks may be connected to a different web access element 227. As indicated at 215 and 225, the communication link by the internet serves to provide two-way data communication between central control 211 and branch bank facilities 218, 219, 228 and 229. In this manner, the availability of the internet is employed to enable the central control facility to communicate digital video, audio, and control data with branch banks whether located in proximity or at a great distance.

The simple system shown schematically in FIG. 14 is only an example for illustration and the number and location of branch bank facilities in the system is subject to great variation. Furthermore, it may be desirable in large systems to have a master central control facility with subsidiary central control facilities in direct communication with certain ones of the branch bank facilities. Also, larger systems might employ multiple private link networks for ATM machine control and/or the ATM network could in part employ secure data communication links through the internet as well as strictly closed circuit communication links.

It should be noted that customer service equipment shown in the referenced patents may be employed in part to implement the present invention, and relevant disclosures in such patents is incorporated by reference herein.

It will be understood that the system of interconnected remote banking facilities as described above is subject to numerous modifications in addition to those described or suggested as will be appreciated by those skilled in the art, and accordingly the scope of the invention is not to be considered to be limited to those examples and modifications expressly described but is to be determined by reference to the appended claims.

1. A communication and control system for multiple untended branch bank facilities and customer stations therein comprising:
A. a central control facility having one or more personnel stations for one or more customer service persons, said central control facility having;
A(1) at least one audio visual personnel station with a plurality of video monitors, communications links from said central control facility to each of said branch bank facilities and means for switching said video monitors to receive customer related visual data from links to selected branch bank facilities;
A(2) at least one video camera for communicating to a selected branch bank facility an image of a service person or other visual information desired to be communicated, said camera having associated therewith a computer station for transmitting data and control signals to a customer station at a branch bank facility;
A(3) a central security control and activity monitoring station with security information links to receive digital data including image data from sensors including video cameras at each of said branch bank facilities; and
A(4) a terminal with digital data links to communicate with automated bulk cash dispensing units and check cashing units;
B. a plurality of remotely located self-contained branch bank facilities not requiring attendant operating personnel, each said branch bank facility having:
B(1) an enclosed structure with intrusion detection and prevention apparatus and an entry control device for limiting access to identifiable customers or other persons authorized for entry;
B(2) said structure being divided into a customer accessible first portion and a second portion accessible only to authorized persons and for equipment servicing or maintenance;
B(3) multiple video cameras at each said branch bank facility situated and controlled to view all parts of at least the said first portion of said structure and at least a part of approaches to said structure, said video cameras being provided with communication apparatus for linking them to said central security control and activity monitoring station;
B(4) an ATM associated with each said branch bank facility having ATM communication links separate from those for security information and customer related visual data;
B(5) at least one customer station having a personal computer terminal configured to communicate with an internet electronic banking site and including visual image communication apparatus connected to link with said audio-visual personnel station at said central control facility;
B(6) a bulk cash dispensing machine capable of dispensing coins and bills of selected denominations;
B(7) a check cashing machine;
B(8) a telephone communication station capable of linking to said one or more personnel stations at said central control facility;
B(9) a night depository unit;
B(10) at least one recording security camera;
whereby bank customers will have a safe and secure location to conduct virtually all forms of banking business either electronically or with aid of bank personnel through live audio visual communication.

2. Apparatus as recited in claim 1 wherein said customer accessible first portion of said structure contains a printer controlled at least in part from one of said personnel stations.

3. Apparatus as recited in claim 1 wherein each said branch bank facility contains a validated bank check producing machine controlled from one of said personnel stations.

4. Apparatus as recited in claim 1 wherein each said entry control device is configured to receive an unlock signal from said central control facility, whereby rapid emergency access to a branch bank facility can be provided for police, fire, or emergency medical service persons.

5. Apparatus as recited in claim 1 wherein at least a plurality of said branch facilities each contain a document scanner capable of transmitting an electronic copy of a document to said central control facility.

6. Apparatus as recited in claim 1 wherein said customer related visual data is received through an internet web site.

7. Apparatus as recited in claim 6 wherein said visual information desired to be transmitted from said central control facility is transmitted from an internet web site.

8. Apparatus as recited in claim 1 wherein said security information links are implemented through the internet.

9. Apparatus as recited in claim 1 wherein each said night depository is accessible from inside the said branch bank facility.

10. Apparatus as recited in claim 1 wherein each said ATM is in view of a video camera having a communication link to said at least one audio visual personnel station.
